(19) United States
(12) Patent Application Publication
(10) Pub. No.: US 2026/0212710 A1
(43) Pub. Date: Jul. 23, 2026

(54) SYSTEMS AND METHODS FOR CHANNEL-AGNOSTIC TELEMETRY DATA PROCESSING AND VEHICLE MANAGEMENT BASED THEREFROM

(71) Applicant: BLINKAI INC., Leander, TX (US)

(72) Inventors: Ankur Raghavbhai KANERIA, Cedar Park, TX (US); Syed Muasir KHALIL, Austin, TX (US)

(21) Appl. No.: 19/096,827

(22) Filed: Apr. 1, 2025

Related U.S. Application Data
(60) Provisional application No. 63/747,122, filed on Jan. 20, 2025.

(51) Int. Cl. G07C 5/00; G07C 5/08

(52) U.S. Cl. CPC G07C 5/008; G07C 5/0841

(57) ABSTRACT

Disclosed are systems and methods for a computerized network that provides a channel-agnostic system for the real-time and/or batch ingestion and processing of telemetry data of vehicles. The system leverages curated AI/ML algorithms to process real-time telemetry data, as well as other electronic and/or digital sources related to vehicle activity, to provide in-depth analysis regarding event attribution, which can correspond to collisions and/or malfunctions, thereby enabling a computationally streamlined, resource-efficient system for performing event analysis and vehicle control and management based therefrom. Indeed, the disclosed framework provides improved configurations and components for the processing of telemetry data, comprehensive event analysis, and collision/malfunction detection, while ensuring adaptability across different data input channels for adaptably by and between resource channels and/or networks.

### CROSS-REFERENCE TO RELATED APPLICATIONS

This application claims the benefit or priority from U.S. Provisional Patent Application No. 63/747,122, filed Jan. 20, 2025, which is incorporated herein by reference in its entirety.

### FIELD OF TECHNOLOGY

The present disclosure generally relates to telemetry data processing, and more specifically to systems and methods for channel-agnostic telemetry data processing and event analysis.

### BRIEF SUMMARY

In some embodiments, the present disclosure provides an exemplary technically improved computer-based method that includes at least the following steps of continuously receiving, by at least one processor of a computing platform, a plurality of vehicle-specific telemetry data associated with a plurality of vehicles. The plurality of vehicle-specific telemetry data for each vehicle may include: a plurality of vehicle-specific sensor data, at least one vehicle-specific location data, at least one location-specific environmental data, at least one audio-video vehicle-specific monitoring data, at least one unstructured vehicle-specific data, or any combination thereof. At least one historical vehicle-specific telemetry dataset for each vehicle may be generated at predefined processing times using the plurality of vehicle-specific telemetry data for each vehicle. A real-time vehicle operational status of each vehicle from the plurality of vehicles may be continuously determined to identify at least one vehicle-specific operational event by continuously inputting a subset of the plurality of vehicle-specific telemetry data and the at least one historical vehicle-specific telemetry dataset for each vehicle into at least one noise filtering algorithm that is trained to output a plurality of filtered vehicle-specific telemetry data for each vehicle. The at least one noise filtering algorithm may be configured to correlate the at least one historical vehicle-specific telemetry dataset and the plurality of vehicle-specific telemetry data in the subset to filter redundant telemetry data, false telemetry data, or both, in the plurality of vehicle-specific telemetry data. The subset of the plurality of vehicle-specific telemetry data during the continuous determining of the real-time vehicle operational status of each vehicle from the plurality of vehicles may facilitate a reduction in a telemetry data processing overhead. The plurality of filtered vehicle-specific telemetry data for each vehicle may be continuously inputted into at least one event detection algorithm that is trained to output: the at least one vehicle-specific operational event, at least one severity classification of the at least one vehicle-specific operational event, and at least one event timestamp of the at least one vehicle-specific operational event. The at least one event detection algorithm may be configured to identify the at least one vehicle-specific operational event for each vehicle based at least in part on a plurality of dependencies between historical vehicle-specific telemetry data in the at least one historical vehicle-specific telemetry dataset, and the plurality of filtered vehicle-specific telemetry data. An event analysis report based at least in part on an identification the at least one vehicle-specific operational event may be generated.

In some embodiments, the present disclosure provides an exemplary technically improved computer-based system that includes at least the following components of at least one processor of a computing platform and at least one non-transitory memory storing computer code. The at least one processor may be configured to execute the computer code that causes the at least one processor to: continuously receive a plurality of vehicle-specific telemetry data associated with a plurality of vehicles; where the plurality of vehicle-specific telemetry data for each vehicle comprises: a plurality of vehicle-specific sensor data, at least one vehicle-specific location data, at least one location-specific environmental data, at least one audio-video vehicle-specific monitoring data, at least one unstructured vehicle-specific data, or any combination thereof; generate, at predefined processing times, using the plurality of vehicle-specific telemetry data for each vehicle, at least one historical vehicle-specific telemetry dataset for each vehicle; continuously determine a real-time vehicle operational status of each vehicle from the plurality of vehicles to identify at least one vehicle-specific operational event by: continuous input of a subset of the plurality of vehicle-specific telemetry data and the at least one historical vehicle-specific telemetry dataset for each vehicle into at least one noise filtering algorithm that is trained to output a plurality of filtered vehicle-specific telemetry data for each vehicle; where the at least one noise filtering algorithm may be configured to correlate the at least one historical vehicle-specific telemetry dataset and the plurality of vehicle-specific telemetry data in the subset to filter redundant telemetry data, false telemetry data, or both, in the plurality of vehicle-specific telemetry data; where the subset of the plurality of vehicle-specific telemetry data may facilitate a reduction in a telemetry data processing overhead during the continuous determining of the real-time vehicle operational status of each vehicle from the plurality of vehicles; continuous input of the plurality of filtered vehicle-specific telemetry data for each vehicle into at least one event detection algorithm that is trained to output: the at least one vehicle-specific operational event, at least one severity classification of the at least one vehicle-specific operational event, and at least one event timestamp of the at least one vehicle-specific operational event; where the at least one event detection algorithm may be configured to identify the at least one vehicle-specific operational event for each vehicle based at least in part on a plurality of dependencies between: historical vehicle-specific telemetry data in the at least one historical vehicle-specific telemetry dataset, and the plurality of filtered vehicle-specific telemetry data; and generate an event analysis report based at least in part on an identification the at least one vehicle-specific operational event.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram showing multiple unstructured data inputs to a central processing platform in accordance with one or more embodiments of the present disclosure;

FIG. 2 is a system block diagram illustrating an exemplary telemetry data ingestion flow to a central processing platform in accordance with one or more embodiments of the present disclosure;

FIG. 3 is a signal flow diagram of the central processing platform that performs channel-agnostic telemetry data processing and event analysis in accordance with one or more embodiments of the present disclosure;

FIG. 4 is a block diagram of a system for channel-agnostic telemetry data processing and event analysis in accordance with one or more embodiments of the present disclosure;

FIG. 5 depicts a block diagram of an exemplary computer-based system/platform in accordance with one or more embodiments of the present disclosure;

FIG. 6 depicts a block diagram of an exemplary computer-based system/platform in accordance with one or more embodiments of the present disclosure;

FIG. 7 depicts a block diagram of another exemplary computer-based system/platform in accordance with one or more embodiments of the present disclosure;

FIGS. 8 and 9 are diagrams illustrating implementations of cloud computing architecture/aspects with respect to which the disclosed technology may be specifically configured to operate, in accordance with one or more embodiments of the present disclosure;

FIG. 9 is a block diagram of a system for channel-agnostic telemetry data processing and event analysis (TDEA) based on a microservices platform in accordance with one or more embodiments of the present disclosure; and

FIG. 10 is a flowchart of a method for channel-agnostic telemetry data processing and event analysis in a computing platform in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

With the increasing proliferation of Internet of Things (IoT) devices, particularly in the automotive domain, the generation of telemetry data has become critical for preventive maintenance, safety, and operational efficiency. However, telemetry data streams may often be noisy, containing false positives or duplicates, especially when sourced from multiple sensors and across varied environmental conditions.

At least some embodiments of the present disclosure provide systems and methods of a computerized framework that addresses these issues, among others, by improved processing of telemetry data, comprehensive event analysis, and collision/malfunction reporting, while ensuring adaptability across different data input channels. As evident from the instant disclosure, the improved capabilities of the disclosed functionality and capabilities of the disclosed framework may provide improved accuracy, efficiency, and may further enable a more streamlined, resource-efficient system for performing event analysis.

In some embodiments, the present disclosure may provide a channel-agnostic system for the real-time and/or batch ingestion and processing of telemetry data. This system may handle data from diverse sources, including, but not limited to, emails, cellular communication, location data (e.g., GPS, for example), International Mobile Equipment Identity (IMEI) numbers, user profile information, SMS, MMS, social media posts/feeds, printed reports and other material, as well as audio/video feeds, and the like, or some combination thereof. The system can incorporate a computerized algorithm to filter noise and detect genuine collision/malfunction events, thus providing in-depth analysis regarding damage severity, affected parts, and repair cost/time estimations, among other benefits those of skill in the art would readily understand from the instant disclosure.

The evolution of telemetry data systems has expanded beyond traditional vehicular sensor networks to encompass a broader spectrum of data sources and input channels. As provided herein, the instant disclosure provides technical improvements for a channel-agnostic system capable of processing diverse data streams while providing improved event analysis, with particular emphasis on vehicular incident detection and classification. The proposed improvements address both the challenges of multi-channel data integration and the complexities of real-time event analysis.

It should be understood that while the discussion herein may focus on event analysis for vehicle activity (e.g., car accident, for example), it should not be construed as limiting, as one of ordinary skill in the art would recognize that telemetry and event data for any type of event can be performed via the disclosed systems and methods without departing from the scope of the instant disclosure.

In some embodiments, implementation of the disclosed channel-agnostic data ingestion framework may provide a fundamental advancement in telemetry data processing. Traditional systems typically focus on structured data from dedicated sensors, but modern applications require the ability to process information from diverse unstructured vehicle-specific data sources including emails, SMS messages, social media feeds, printed reports, audio/video streams, and the like. This may necessitate the development of specialized data parsers and preprocessors capable of extracting relevant information from unstructured and semi-structured data sources. Natural Language Processing (NLP) techniques, including advanced text analytics and sentiment analysis, may be employed to extract meaningful incident-related information from textual sources such as social media posts or email communications.

Moreover, integration of computer vision and audio processing capabilities may significantly enhance the system's ability to process multimedia content. Implementing deep learning models specifically designed for video analysis may enable the automatic detection and classification of collision events from surveillance footage or dash cam recordings. Similarly, audio processing algorithms may analyze sound recordings to identify characteristic acoustic signatures associated with various types of vehicular incidents. These capabilities, therefore, may be complemented by the disclosed synchronization mechanisms to align and correlate data from different channels and timestamps.

In some embodiments, data quality assurance and noise filtering mechanisms may be particularly critical in a multi-channel system. The development of advanced filtering algorithms that may distinguish genuine incident reports and telemetry data from false positives or irrelevant information may be essential. This may include implementing machine learning-based classification systems trained on extensive datasets of verified incidents to identify characteristic patterns across different data channels. The system can also account for varying levels of data quality and reliability across different input channels, implementing weighted analysis mechanisms that consider the credibility and accuracy of different data sources.

In some embodiments, the incorporation of automated damage assessment capabilities may represent another significant technical improvement. By analyzing telemetry data alongside visual information and incident reports, the system may provide detailed estimates of damage severity and affected components. The implementation of pattern recognition algorithms may be used to correlate specific telemetry patterns with known damage profiles, complemented by computer vision systems capable of identifying visible damage from image and video sources. Integration with comprehensive vehicle component databases and repair cost information enables the system to generate accurate repair time and cost estimations.

In some embodiments, real-time processing capabilities may be enhanced to handle the increased complexity of multi-channel data ingestion while maintaining system responsiveness. This may involve implementing parallel processing architectures such as processing over multiple computing machines, for example, that may efficiently distribute the workload across the multiple processing machines, with specialized processors handling different types of input data. The system may incorporate mechanisms that may prioritize the processing of critical incident data while managing less time-sensitive information through batch processing pipelines.

In some embodiments, data integration and correlation mechanisms may be improved to enable effective cross-channel analysis. This may include deploying event correlation algorithms that may identify relationships between incidents reported through different channels and combine relevant information into comprehensive event profiles. Implementation of graph-based data structures may facilitate the identification of complex relationships between different data points and may enable more effective event clustering and classification.

In some embodiments, the development of advanced metadata management systems may be needed for maintaining data provenance and enabling effective data governance in a multi-channel environment. This may include implementing detailed tracking mechanisms for data sources, processing steps, and/or analysis results, enabling full audit trails for incident investigations. The system may maintain comprehensive data/metadata about the reliability and accuracy of different data sources, using this information to weight and prioritize different inputs in the analysis process.

In some embodiments, privacy and security considerations may become more complex in a multi-channel system, particularly when dealing with sensitive personal information from social media or communication channels. Thus, implementation of data anonymization techniques and secure processing pipelines may be used, along with mechanisms for managing access control and data sharing across different stakeholders. The system may comply with various privacy regulations while maintaining the utility of the data for incident analysis purposes.

In some embodiments, the integration of contextual analysis capabilities may enhance the system's ability to understand and classify events. This may include incorporating information about local traffic patterns, weather conditions, and historical incident data, as well as analyzing social media trends and news reports that might provide additional context for incident analysis. The system may implement context awareness mechanisms that may adapt analysis parameters based on current conditions and historical patterns.

In some embodiments, reporting and visualization capabilities may be enhanced to effectively present analysis results from multiple data channels. This may include developing interactive visualization tools that may present integrated views of incident data from different sources, enabling analysts to explore relationships between different data points and understand the full context of each incident. Implementation of customizable reporting frameworks that may generate targeted analysis reports for different stakeholders may also be needed.

In some embodiments, the development of feedback mechanisms for continuous system improvement may represent another area for technical advancement. This may include implementing machine learning systems that may learn from historical analysis results and user feedback to improve the accuracy of incident classification and damage assessment algorithms. The system may maintain comprehensive performance metrics across different data channels and analysis types, using this information to identify areas for improvement and optimization.

In some embodiments, these technical improvements, when implemented cohesively, may create a channel-agnostic system capable of processing diverse telemetry data sources while providing accurate and comprehensive incident analysis. The resulting system may better serve the needs of various stakeholders, from emergency responders to insurance companies, while maintaining high standards of data quality and privacy protection. Continued development in these areas may be essential for addressing the evolving challenges of multi-channel telemetry data analysis and incident classification.

In some embodiments, the disclosed systems and methods may be implemented via an application that executes on a user device, on a network device (e.g., server(s)), peer device, peripheral device, on a cloud system, on a sensor on a vehicle, via a processor(s) on a vehicle, on a third-party device, and the like, or some combination thereof. Such application may include functionality provided via an artificial intelligence and/or machine learning (AI/ML) model, which may include a large language model (LLM). Such application may be configured and/or installed as an augmenting script, program or application (e.g., a plug-in or extension) to another application or program, which may be provided by a cloud system/service/platform, third party, entity, user, and the like.

In some embodiments, AI/ML analysis may involve the disclosed system/framework executing any type of known or to be known computational analysis technique, algorithm, mechanism or technology to analyze the telemetry and event data, and/or any other type of data/metadata as discussed hereinbelow.

In some embodiments, the system/framework may execute and/or include a specific trained AI/ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, the system/framework may leverage a large language model (LLM), whether known or to be known. An LLM may be a type of AI system designed to understand and generate human-like text based on the input it receives. The LLM may implement technology that may involve deep learning, training data, statistical language models (SLMs) and/or natural language processing (NLP). As discussed herein, such known or to be known SLMs and/or NLPs may be utilized for, but not limited to, machine translation, speech recognition, text/speech generation, sentiment analysis, conversational dialog, and the like, or some combination thereof, as is capable with LLMs. Large language models may be built using deep learning techniques, specifically using a type of neural network called a transformer. These networks have many layers and millions or even billions of parameters. LLMs may be trained on vast amounts of text data from the internet, books, articles, and other sources to learn grammar, facts, and reasoning abilities. The training data may help the models understand context and language patterns. LLMs may use NLP techniques to process and understand text. This may include tasks like tokenization, part-of-speech tagging, and/or named entity recognition.

In some embodiments, LLMs may include functionality related to, but not limited to, text generation, language translation, text summarization, question answering, conversational AI, text classification, language understanding, content generation, and the like. Accordingly, LLMs may generate, comprehend, analyze and/or output human-like outputs (e.g., text, speech, audio, video, and the like) based on a given input, prompt and/or context. Accordingly, LLMs, which may be characterized as transformer-based LLMs, may involve deep learning architectures that may utilize self-attention mechanisms and/or massive-scale pre-training on input data to achieve NLP understanding and generation. Such current and to-be-developed models may aid AI systems in handling human language and human interactions therefrom.

In some embodiments, the system/framework may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, the disclosed system may implement an XGBoost algorithm for regression and/or classification to analyze the telemetry data, as discussed herein.

In some embodiments and, optionally, in combination of any embodiment described above or below, a neural network technique may be one of, without limitation, feedforward neural network, radial basis function network, recurrent neural network, convolutional network (e.g., U-net) and/or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and/or connection weights. For example, the topology of a neural network may include a configuration of nodes of the neural network and connections between such nodes.

In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, and/or other type of mathematical function that may represent a threshold at which the node is activated.

In some embodiments and, optionally, in combination of any embodiment described above or below, the aggregation function may be a mathematical function that may combine (e.g., sum, product, and the like) input signals to the node.

In some embodiments and, optionally, in combination of any embodiment described above or below, an output of the aggregation function may be used as input to the activation function.

In some embodiments and, optionally, in combination of any embodiment described above or below, the bias may be a constant value or function that may be used by the aggregation function and/or the activation function to make the node more or less likely to be activated.

In some embodiments, the methods and systems for channel-agnostic telemetry data processing and event analysis may be performed in a number of stage (not necessarily in the order shown hereinbelow) using associated hardware and/or software modules as described in the following figures. The first part of the system may include a channel-agnostic ingestion of telemetry data. The second part of the system may include detection and in-depth collision/malfunction analysis. The third part of the system may include detection and filtering of noise in the telemetry data. The fourth part of the system may include an analysis of pre-written collision or accident reports.

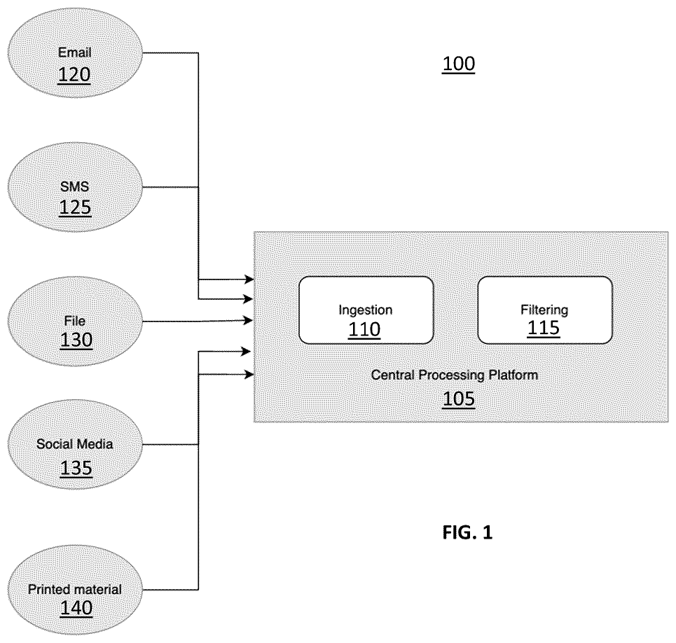

FIG. 1 is a block diagram 100 showing multiple unstructured data inputs to a central processing platform 105 in accordance with one or more embodiments of the present disclosure. The block diagram 100 shows the multiple unstructured data input sources such as for example, but not limited to an email 120, a short messaging service (SMS) text message 125, a data file 130, a social media 135 data, and/or printed material 140 that are inputted into the central processing platform 105. The block diagram 100 illustrates a robust framework designed to capture and process telemetry events from various source devices, such as vehicles, regardless of the communication channel. The central processing platform 105 may include at least one ingestion software algorithm 110 for ingesting a plurality of vehicle-specific telemetry data associated with a plurality of vehicles, and at least one noise filtering algorithm 115 to generate a plurality of filtered vehicle-specific telemetry data as will be discussed hereinbelow.

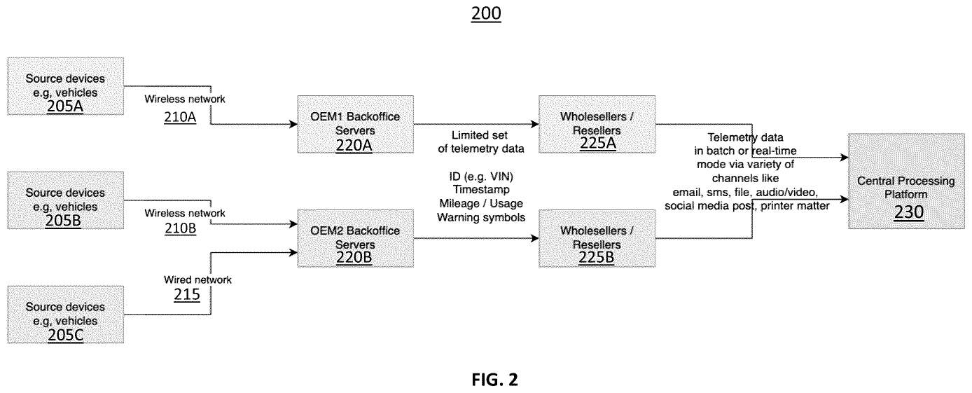

FIG. 2 is a system block diagram 200 illustrating an exemplary telemetry data ingestion flow to a central processing platform 230 in accordance with one or more embodiments of the present disclosure. Telemetry data generated by a plurality of N data source devices denoted as 205A, 205B, and 205C such as generated from a vehicle, for example, may be transmitted to the OEM's back-office servers denoted 220A and 220B over a wired network 215 or a wireless network 210A and 210B. In addition to the unstructured telemetry data shown in FIG. 1, the telemetry data may also include sensor output data from sensors coupled to any of a plurality of vehicles.

In some embodiments, the system may segregate incoming events represented by a plurality of telemetry data associated with a plurality of vehicles represented by the plurality of N data sources using a plurality of vehicle or device identifiers such as vehicle identification number (VIN) and forwards a limited dataset, such as VIN, timestamp, mileage, and warning symbols, to relevant stakeholders such as wholesalers and/or resellers 225A and 225B, for example. The framework (e.g., the central processing platform 230) may integrate either with the OEM back-office servers 220A and 220B or with wholesalers and resellers 225A and 225B to receive this limited set of telemetry data in either batch or real-time fashion over a variety of channels including Emails, files, SMS, social media, audio/video content, printed material.

In some embodiments, modern vehicle telemetry systems have evolved to accommodate complex data transmission and processing requirements across diverse stakeholder networks. The fundamental architecture begins with source devices (205A, 205B, 205C), primarily vehicles, transmitting telemetry data to Original Equipment Manufacturer (OEM) back-office servers (220A and 220B) through various network protocols. This data transmission may occur over both wired and wireless networks as shown FIG. 2, ensuring robust connectivity and continuous data flow even in challenging environments.

In some embodiment, the system as shown in FIG. 2 may provide functionality for computerized data segregation mechanisms that process incoming events based on unique device identifiers, primarily Vehicle Identification Numbers (VINs). This segregation may enable targeted data distribution, where specific subsets of information—including VIN, timestamp, mileage, and/or warning symbols—may be systematically forwarded to relevant stakeholders within the distribution network, particularly wholesalers and resellers (225A and 225B). The framework's flexibility allows for integration either directly with OEM back-office servers (220A and 220B) or with downstream stakeholders (225A and 225B), facilitating efficient data flow throughout the supply chain.

In some embodiments, FIGS. 1-2 illustrate that the plurality of telemetry data associated with the plurality of vehicles may include the unstructured data (e.g., email 120, SMS 125, file 130, social media 135, printed material 140) as shown in FIG. 1 as well as the data generated from the plurality of source devices (such as vehicle sensor data, audio data from audio devices coupled to each vehicle, video data from video devices coupled to each vehicle, or filming each vehicle). After processing of the plurality of telemetry data associated with the plurality of vehicles either by the OEM Backoffice Servers 220A and 220B and/or servers associated with the wholesellers/resellers 225A and 225B, a volume of data of the plurality of telemetry data associated with the plurality of vehicles may be reduced and/or further transformed using the plurality of vehicle identifiers such as the VIN, to generate the plurality of vehicle-specific telemetry data for each vehicle. This data volume reduction may also facilitate a real-time processing of the telemetry data by reducing telemetry data processing overhead.

Thus, in some embodiments, the plurality of vehicle-specific telemetry data for each vehicle may include a plurality of vehicle-specific sensor data (e.g., vehicle sensor output data), at least one vehicle-specific location data (e.g., GPS location of the car), at least one location-specific environmental data (e.g., local weather data at the car location), at least one audio-video vehicle-specific monitoring data (e.g., audio to assess noises indicative of a collision and/or video of the vehicle during a collision), at least one unstructured vehicle-specific data (police reports, insurance reports,, or any combination thereof.

In some embodiments, a distinguishing technical characteristic of this system is its channel-agnostic approach to data reception and processing. The framework may accept telemetry data through multiple communication channels, including traditional methods like email and file transfers, as well as modern platforms such as SMS and social media. Additionally, the system can process audio and video content (such as from image and audio devices, for example, coupled to each vehicle), along with printed materials, making it uniquely capable of handling diverse data formats and sources. This multi-channel capability may ensure comprehensive data capture and analysis, regardless of the original format or transmission method.

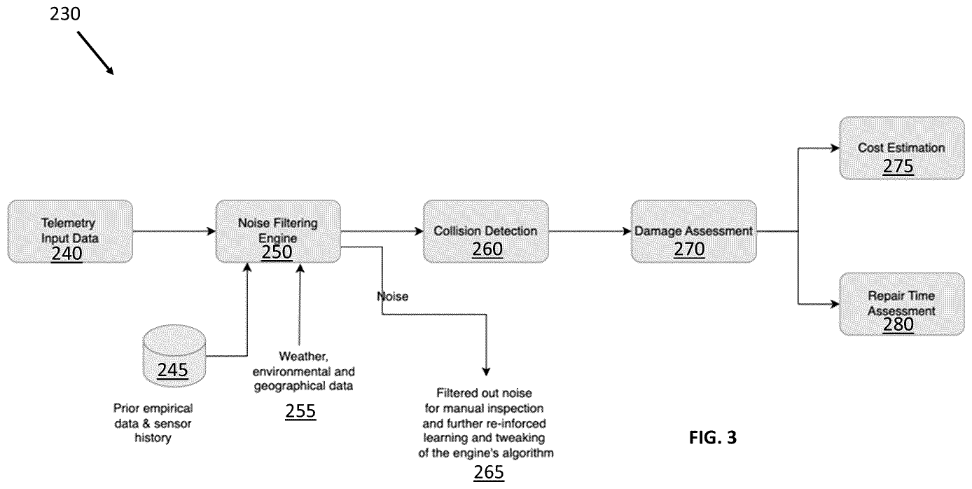

FIG. 3 is a signal flow diagram of the central processing platform 230 that performs channel-agnostic telemetry data processing and event analysis in accordance with one or more embodiments of the present disclosure. Telemetry input data 240 (e.g., the plurality of vehicle-specific telemetry data) may be received from the plurality of data sources 205A, 205B, 205C as shown in FIG. 2. The telemetry input data 240 (e.g., the plurality of vehicle-specific telemetry data associated with the plurality of vehicles), prior empirical data and sensor data 245 for each vehicle (e.g., at least one historical vehicle-specific telemetry dataset for each vehicle), and/or weather, environmental and/or geographical data 255 may be inputted into a noise filtering engine 250 which is configured to filter noise and generate a plurality of filtered vehicle-specific telemetry data associated with the plurality of vehicles as described hereinbelow. The noise filtering engine 250 may be configured to correlate the plurality of vehicle-specific telemetry data associated with the plurality of vehicles and least one historical vehicle-specific telemetry dataset to filter redundant telemetry data, false telemetry data, or both, in the plurality of vehicle-specific telemetry data.

In some embodiments, the plurality of filtered vehicle-specific telemetry data may input into a collision detection algorithm 260 (e.g., at least one event detection algorithm) that is trained to output at least one vehicle-specific operational event (e.g., a vehicle collision), at least one severity classification of the at least one vehicle-specific operational event (e.g., how severe was the detected collision) and at least one event timestamp of the at least one vehicle-specific operational event (e.g., the time of the collision).

In some embodiments, when a collision is detected by the collision detection algorithm 260, the central processing platform 230 may use a damage assessment algorithm 270 to assess the damage including a cost estimation 275 and a repair time assessment 280 to repair the vehicle damage.

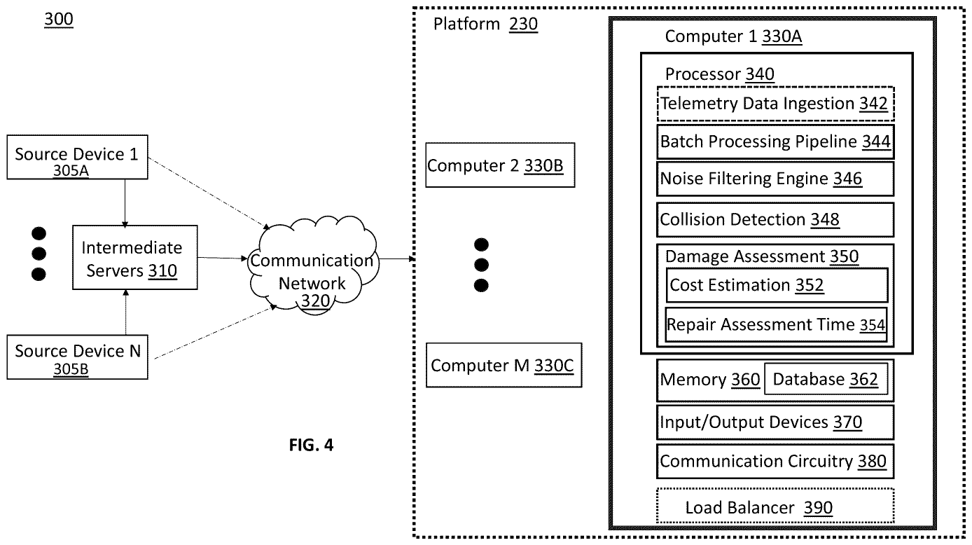

FIG. 4 is a block diagram of a system 300 for channel-agnostic telemetry data processing and event analysis in accordance with one or more embodiments of the present disclosure. The system may include a plurality of N source devices denoted Source Device 1 305A . . . Source Device N 305B where N is any positive integer. The plurality of N source devices may be generate a plurality of telemetry data associated with a plurality of vehicles.

In some embodiments, the plurality of telemetry data associated with a plurality of vehicles may be sent to intermediate servers 310 such as for example the OEM BackOffice server 220A and 220B and/or wholesellers/Resellers servers 225A and 225B. These servers may reduce the plurality of telemetry data and may segregated the data according to a plurality of vehicle identifier such as the VIN to transform the plurality of telemetry data into a plurality of vehicle-specific telemetry data, which may be ingested by the platform 230 via a communication network 320.

In some embodiments, the platform 320 may include a plurality of M computers or computing machines denoted Computer 1 330A, Computer 2 330B, . . . Computer M 330C where M is a positive integer. Each of the plurality of M computers may include a processor 340, a non-transitory memory 360, input and/or output devices 370, a communication circuitry for communicating with each of the elements in the platform 230.

In some embodiments, the processor 340 may be configured to execute software modules that may include a batch processing data pipeline 344, a noise filtering engine 346, a collision detection algorithm 348, and a damage assessment algorithm 350 that may further include algorithms for computing cost estimation 352 and repair assessment time 354. Any of these software modules may be implemented by any number of algorithms or machine learning models.

In some embodiments, the platform 230 may use batch processing data pipeline 344 to generate, at predefined processing times (e.g., batch processing times), at least one historical vehicle-specific telemetry dataset for each vehicle using the plurality of vehicle-specific telemetry data for each vehicle (e.g., the full set of real-time telemetry data).

In some embodiments, the non-transitory memory 360 may store data in a database 362. The data stored in the database 362 may include the plurality of vehicle-specific telemetry data and data generated by the batch processing data pipeline 344 such as at least one historical vehicle-specific dataset for each vehicle from the plurality of vehicles.

In some embodiments, one of the computing devices such as Computer 1 330A may be designated (as a master computer) to control the operation and telemetry data processing overhead of platform 230 for processing the plurality of vehicle-specific telemetry data associated with the plurality of vehicles. The telemetry data processing overhead may be controlled by a load balancer 390 (shown in a dotted rectangle), which may be configured to add or subtract any number of computing machines from the plurality of M computers depending on the amount of telemetry data to be processed by the platform 230.

Optionally, in some embodiments, the plurality of telemetry data (dotted lines) from the plurality of N data sources may be sent directly to the platform 230 (e.g., bypassing the intermediate servers 310) and transformed optionally by a telemetry data ingestion module 342 (shown in a dotted rectangle) to segregate the plurality of telemetry data using the plurality of vehicle identifiers into the plurality of vehicle-specific telemetry data.

In some embodiments, the telemetry data processing overhead may be also controlled by monitoring only a subset of the plurality of vehicle-specific telemetry data for each vehicle. This reduced number of vehicle-specific telemetry data in the subset may be identified as critical data needed to assess a real-time operational status of each vehicle over the plurality of vehicles without loading the processing system. Thus, stated differently, the subset of the plurality of vehicle-specific telemetry data facilitates a reduction in a telemetry data processing overhead during the continuous determining of the real-time vehicle operational status of each vehicle from the plurality of vehicles.

In some embodiments, the continuous determining of a real-time vehicle operational status of each vehicle from the plurality of vehicles enables the system 300 to efficiently monitor over time, the operational status of each vehicle to determine the vehicle is operating normally or to identify at least one vehicle-specific operational event such as a collision or imminent failure of critical parts in the vehicle.

In some embodiments, the noise filtering engine 346 may continuously receive the subset of the plurality of vehicle-specific telemetry data and the at least one historical vehicle-specific telemetry dataset for each vehicle, which are inputted the noise filtering engine/algorithm 346 that is trained to output a plurality of filtered vehicle-specific telemetry data for each vehicle. The noise filtering engine 346 may be configured to correlate the at least one historical vehicle-specific telemetry dataset and the plurality of vehicle-specific telemetry data in the subset to filter redundant telemetry data, false telemetry data, or both, in the plurality of vehicle-specific telemetry data.

In some embodiments, the plurality of filtered vehicle-specific telemetry data for each vehicle may be continuously inputted into at least one event detection algorithm (e.g., the collision detection algorithm 348) that is trained to output the at least one vehicle-specific operational event, at least one severity classification of the at least one vehicle-specific operational event, and at least one event timestamp of the at least one vehicle-specific operational event (e.g., time of the collision or a vehicle part failure). The at least one event detection algorithm may be configured to identify the at least one vehicle-specific operational event for each vehicle based at least in part on a plurality of dependencies between historical vehicle-specific telemetry data in the at least one historical vehicle-specific telemetry dataset, and the plurality of filtered vehicle-specific telemetry data. The at least one severity classification of the at least one vehicle collision may be a classification of a drivable vehicle, a minorly damaged vehicle, a moderately damaged vehicle, or a severely damaged vehicle.

Note that the key features of the system 300 may include:
Ability to handle both real-time and batch feeds for incoming telemetry data.
Noise reduction through the identification of redundant signals.
Real-time telemetry data analysis using a novel algorithm that considers sensor cohesion, prior sensor history, and sensor life spans specific to OEM specifications.
Geo-spatial parameters like weather patterns, temperature, and humidity for more accurate detection of events.

The complexity and volume of modern telemetry data may present significant challenges that exceed human analytical capabilities, necessitating the implementation of advanced artificial intelligence and machine learning systems. A single vehicle may generate thousands of data points per second from numerous sensors, including engine performance metrics, environmental readings, acceleration data, GPS coordinates, and/or system status indicators. This data stream may become exponentially more complex when considering an entire fleet of vehicles (e.g., the plurality of vehicles), creating a multi-dimensional dataset that may incorporate temporal, spatial, and mechanical variables across numerous vehicles simultaneously.

The challenge may be further compounded by the need to analyze this data in real-time or near-real-time conditions. Human analysts, despite their expertise, cannot process the sheer volume of incoming data points quickly enough to identify critical patterns and/or anomalies that might indicate an operational event, such as an imminent failure or accident. Additionally, the interconnected nature of vehicle systems may mean that a single event might manifest across multiple sensor readings in subtle ways that are difficult for human observers to correlate without computational assistance. For example, a potential engine failure may be preceded by minor variations across dozens of sensors over an extended period, creating a pattern that may become apparent when analyzed through AI/ML algorithms.

In some embodiments, the introduction of multi-channel data sources, including social media feeds, email communications, and audio/video content, may further add another layer of complexity to the analysis process. These unstructured data sources may be correlated with traditional telemetry data to provide a comprehensive understanding of vehicle events and/or conditions. AI/ML applications may facilitate this type of cross-channel analysis, being able to identify relevant patterns and relationships across diverse data types that may be impossible for human analysts to process manually. These systems such as the system 300 may continuously learn from new data, adapting their analysis models to account for emerging patterns and improving their accuracy over time. Furthermore, AI/ML systems may simultaneously consider numerous contextual factors, such as weather conditions, traffic patterns, and historical maintenance records, to provide more accurate and nuanced analysis than would be possible through human interpretation alone.

In some embodiments, data handling capabilities of the system 300 may be enhanced by its ability to process information in both real-time and batch modes. This dual-processing capability allows for immediate analysis of critical telemetry data while efficiently managing larger datasets through scheduled batch processing. The framework may implement noise reduction algorithms that identify and filter redundant signals, ensuring data quality and reducing processing overhead.

In some embodiments, the system 300 may provide a novel algorithmic approach that may enable the real-time telemetry data analysis provided herein. The real time analysis may provide a real-time operational status (e.g., normal, imminent failure of vehicle parts, and/or accident) of each vehicle from the plurality of vehicles. This algorithm may incorporate multiple parameters to ensure accurate event detection and classification. It may consider sensor cohesion, evaluating the relationships and correlations between different sensor readings to validate event detection. The algorithm may also take into account prior sensor history, enabling pattern recognition and anomaly detection based on historical performance data. Furthermore, it may incorporate sensor life span specifications provided by OEMs, ensuring that sensor reliability and degradation factors may be considered in the analysis process.

In some embodiments, the integration of geo-spatial parameters may significantly enhance the system's analytical capabilities. By incorporating real-time weather patterns, temperature data, and humidity levels, the system 300 may provide more accurate event detection and classification. These environmental factors may be crucial for understanding the context of telemetry data and may significantly impact the interpretation of sensor readings. For instance, brake performance data might be interpreted differently under wet conditions versus dry conditions, or sensor readings may need to be adjusted based on temperature variations.

In some embodiments, the framework's architecture may provide scalability and adaptability, allowing for easy integration of new data sources and/or analysis parameters. This flexibility may ensure that the system 300 may evolve alongside technological advancements in vehicle telematics and/or changing stakeholder requirements. The combination of real-time processing capabilities, noise reduction algorithms, and/or comprehensive environmental factor integration may create a robust platform for telemetry data analysis and distribution.

In some embodiments, security and data privacy considerations may be inherently built into the system's design, ensuring that sensitive vehicle and operational data may be protected throughout the transmission and processing pipeline. Access controls and data encryption mechanisms may protect information while allowing authorized stakeholders to receive their designated data subsets. This balanced approach to data sharing and protection may ensure that the system meets both operational requirements and privacy regulations.

In some embodiments, the system 300 may generate an event analysis report based at least in part on an identification the at least one vehicle-specific operational event.

In some embodiments, the system 300 may generate the event analysis report in response to a user request. The requesting user may be but is not limited to the vehicle owner, vehicle manufacturer, vehicle parts manufacturer, insurance company, and/or police inquiry.

In some embodiments, the system 300 may consider provide an exhaustive analysis of the event, detailing:
Nature and severity: Categorizing or classifying of the vehicle-specific operational event (e.g., collision event) as minor, moderate, or severe.
Vehicle operability: Assessing whether the vehicle remains drivable post-event.
Damage analysis: Identifying affected vehicle components (both interior and exterior) that require repair or service. Also identifying the impacted areas such front, rear, sides, or interior damage to engine and other parts.
Repair timeline and cost estimation: Generating a comprehensive timeline and cost projection for the necessary repairs.

In some embodiments, the primary classification mechanism of the system 300 may employ a nuanced approach to incident categorization and/or classification of the vehicle-specific operational event, moving beyond binary collision detection to establish detailed severity classifications. Incidents may be systematically evaluated and categorized as minor, moderate, or severe based on multiple data points, including impact force measurements, structural sensor readings, and airbag deployment status. This granular classification may enable more accurate response prioritization and resource allocation for emergency services and/or insurance providers.

In some embodiments, real-time vehicle operability assessment may form a critical component of the analysis framework, providing immediate insights into the vehicle's post-incident functionality. The system may analyze data from multiple vehicle subsystems, including powertrain, steering, braking, and/or electrical systems by continuously receiving the plurality of vehicle-specific telemetry data so as to determine whether the vehicle remains safely operable. This assessment may consider both immediate safety concerns and/or potential long-term operational risks, providing crucial guidance for first responders and vehicle operators in the immediate aftermath of an incident.

In some embodiments, damage analysis functionality may utilize, for example, a sensor fusion approach to create a comprehensive map of affected vehicle components. This analysis may encompass both exterior damage assessment, utilizing impact sensors and/or structural deformation data, and/or interior system evaluation, drawing on diagnostic information from the vehicle's electronic control units. The system 300 may precisely identify affected areas, from exterior panels and structural components to internal mechanical and electrical systems, providing a detailed assessment of necessary repairs and/or replacements.

In some embodiments, in terms of repair planning, the system 300 may generate detailed timeline and/or cost projections by combining damage assessment data with comprehensive repair databases. These projections may account for multiple variables, including parts availability, labor requirements, and/or regional cost variations. The system 300 may consider the interdependencies between different repair procedures, thus enabling optimal repair sequencing and/or accurate timeline estimation. Cost projections may be generated through analysis of historical repair data, current parts pricing, and/or regional labor rates, providing stakeholders with reliable financial planning information.

In some embodiments, this integrated analysis framework provided by the system 300 may support multiple stakeholder requirements simultaneously. Insurance providers may receive detailed damage assessments supporting rapid claims processing, repair facilities may obtain comprehensive repair planning information, and/or vehicle owners may receive clear communications about vehicle status and/or repair expectations. The system 300 may be able to process and analyze vast amounts of sensor data in real-time, combined with its damage assessment algorithms, to enable a more efficient incident response and/or repair processes while reducing the potential for overlooked damage and/or unnecessary repairs. This comprehensive approach to post-incident analysis may represent a significant advancement in vehicle damage assessment technology, thus providing stakeholders with unprecedented levels of detail and accuracy in incident analysis and repair planning.

In some embodiments, the noise filtering engine 346 may filter noise from the plurality of vehicle-specific telemetry by leveraging empirical data and sensor history, using environmental and geographical parameters to adjust accuracy, including weather impact (7.69%), other environmental/geographical factors (2.31%), historical data (36.7%), correlated telemetry signals as a group (53.3%). The weighted percentages are not by way of limitation of the embodiments disclosed herein. Such weight percentages are examples only, as such weights may be predetermined, set, dynamically determined, and/or otherwise defined to different variables, which may be based on, but not limited to, a time, date, user, vehicle, event type, data type (e.g., weather, geography, environment, climate, history, telemetry, for example) and the like, or some combination thereof.

In some embodiments, the system 300 may also provide configurability to automatically and/or dynamically adjust these weighting factors, enhancing the flexibility and precision of the filtering process.

In some embodiments, the filtering mechanisms of the system 300 may be based on correlated telemetry signals, which, for example, may account for n % (e.g., 53.3%) of the filtering weight. This approach may recognize that vehicle sensors operate as interconnected networks rather than isolated data points. By analyzing signals as cohesive groups, the system 300 may identify anomalous readings that may deviate from expected correlation patterns. This method may be utilized in distinguishing genuine events from sensor malfunctions and/or environmental interference, as legitimate vehicle events may typically generate consistent patterns across multiple sensor groups.

In some embodiments, historical data integration may form the second most significant component of the filtering system, contributing, for example, to 36.7% of the weighting factor. The system 300 may maintain comprehensive sensor histories, enabling pattern recognition and/or establishing baseline performance metrics for individual sensors and sensor groups. This historical analysis may allow the system 300 to identify gradual sensor degradation and adjust filtering parameters, accordingly, ensuring consistent accuracy over the sensor's lifecycle.

In some embodiments, weather impact consideration may account for 7.69% of the filtering weight, reflecting the significant influence of atmospheric conditions on sensor performance. The system 300 may incorporate real-time weather data to adjust filtering parameters based on known environmental effects on specific sensor types. This adaptation may be crucial for maintaining accuracy across varying weather conditions, particularly for exterior sensors exposed to environmental elements.

In some embodiments, additional environmental and geographical parameters may contribute, for example, 2.31% of the filtering weight, encompassing factors such as altitude, temperature variations, and/or terrain characteristics. These parameters may help contextualize sensor readings within their operational environment, enabling more precise noise filtering based on location-specific conditions.

In some embodiments, the configurability of the system 300 may represent a key technical advancement, allowing users and/or the system/framework/application to adjust weighting factors based on specific operational requirements or environmental conditions. This flexibility may enable an optimization for different vehicle types, geographical regions, and/or seasonal variations. The adjustable weighting system may be implemented through a sophisticated algorithm that maintains internal consistency while allowing parameter modification, ensuring that changes to individual weights may result in coherent overall filtering behavior.

In some embodiments, with regard to the damage assessment, the system 300 may use the damage assessment algorithm 350 to interpret human-written reports (e.g., police or insurance reports) and/or predict affected parts and sensors. The algorithm may consider, for example:
The vehicle's make, model, and manufacturer (4.8%).
Empirical data from previous events involving similar vehicles (20.2%).
The detailed explanation within the report (75%).
   The weight percentages shown above are examples only, and not by way of limitation of the embodiments disclosed herein. Such weights may be predetermined, set, dynamically determined, or otherwise defined to different variables, which may be based on, but not limited to, a time, date, user, vehicle, event type, data type (e.g., make, model, empirical data, and the like, for example) and the like, or some combination thereof.

In some embodiments, such weights may also be adjustable and/or may be dynamically determined in real-time (or near-real-time), which may be based on a set of criteria, requests and/or current data readings, for example, thereby allowing for fine-tuned analysis based on different report structures or content.

In some embodiments, the electronic report analysis may involve parsing the electronic report documents and extracting information based on a request and/or criteria (e.g., mine for and discover vehicle information, for example). Such analysis may be performed via any of the above discussed AI/ML and/or LLM models, and/or may be performed via conversion of the report from one format to another format so that the system 300 may properly parse and identify the requested data (e.g., perform Optical Character Recognition (OCR), for example, of a document so that the characters may become computer-readable according to an implemented application, for example).

In some embodiments, exemplary inventive, specially programmed computing systems/platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computing machine”, “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a vehicle sensor, a file, a contact,, an email, a social media post, a map, an entire application, etc.

In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD, NetBSD, OpenBSD; (2) Linux; (3) Microsoft Windows; (4) OS X (MacOS); (5) MacOS 11; (6) Solaris; (7) Android; (8) iOS; (9) Embedded Linux; (10) Tizen; (11) WebOS; (12) IBM i; (13) IBM AIX; (14) Binary Runtime Environment for Wireless (BREW); (15) Cocoa (API); (16) Cocoa Touch; (17) Java Platforms; (18) JavaFX; (19) JavaFX Mobile; (20) Microsoft DirectX; (21) .NET Framework; (22) Silverlight; (23) Open Web Platform; (24) Oracle Database; (25) Qt; (26) Eclipse Rich Client Platform; (27) SAP NetWeaver; (28) Smartface; and/or (29) Windows Runtime.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, exemplary inventive computer-based systems/platforms, exemplary inventive computer-based devices, and/or exemplary inventive computer-based components of the present disclosure may be configured to handle numerous concurrent source data generated from the plurality of N source devices 305A . . . 305N where N may be, but is not limited to, at least 100 (e.g., but not limited to, 100-999), at least 1,000 (e.g., but not limited to, 1,000-9,999) , at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), and so on.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

As used herein, the terms “proximity detection,” “locating,” “location data,” “location information,” and “location tracking” refer to any form of location tracking technology or locating method that can be used to provide a location of, for example, a particular computing device/system/platform of the present disclosure and/or any associated computing devices, based at least in part on one or more of the following techniques/devices, without limitation: accelerometer(s), gyroscope(s), Global Positioning Systems (GPS); GPS accessed using Bluetooth™; GPS accessed using any reasonable form of wireless and/or non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the exemplary inventive computer-based systems/platforms, the exemplary inventive computer-based devices, and/or the exemplary inventive computer-based components of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

The aforementioned examples are, of course, illustrative and not restrictive.

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session or can refer to an automated software application which receives the data and stores or processes the data.

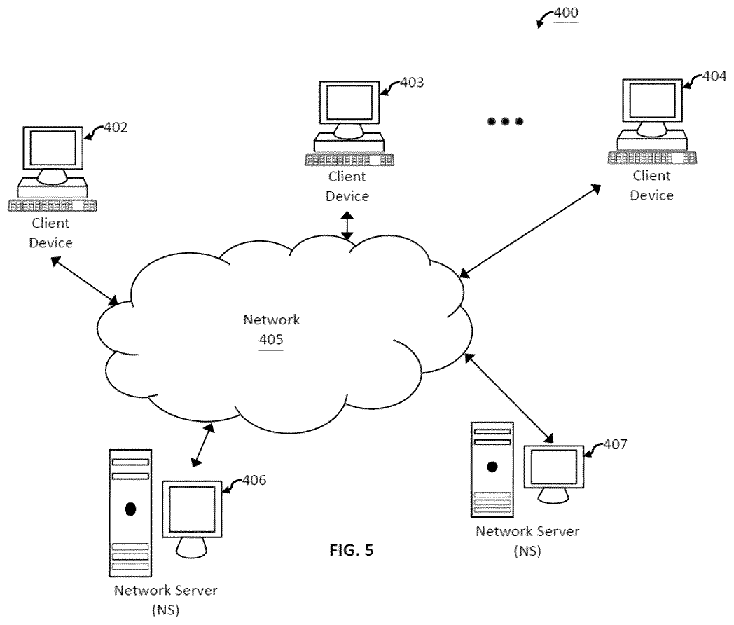

FIGS. 5-8 hereinbelow disclose possible exemplary systems for implementing the channel-agnostic telemetry data processing and event analysis as described above, such as in FIG. 4. These exemplary systems are merely for conceptual clarity and not by way of limitation of the embodiments disclosed herein.

FIG. 5 depicts a block diagram of an exemplary computer-based system/platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform 400 may be configured to manage a large number of source devices generating the plurality of telemetry data, as detailed herein. In some embodiments, the exemplary computer-based system/platform 400 may be based on a scalable computer and/or network architecture that incorporates varies strategies for assessing the data, caching, searching, and/or database connection pooling. An example of the scalable architecture is an architecture that is capable of operating multiple servers.

In some embodiments, referring to FIG. 5, source devices 402-404 (e.g., client devices) of the exemplary computer-based system/platform 400 may include virtually any computing device capable of receiving and sending a message over a network (e.g., cloud network), such as network 405, to and from another computing device, such as servers 406 and 407, each other, and the like. Here, source devices 402-404 may be the plurality of N source data devices 305A . . . 305N. In some embodiments, the source devices 402-404 may be personal computers, multiprocessor systems, microprocessor-based or programmable consumer electronics, network PCs, and the like.

In some embodiments, one or more source devices within source devices 402-404 may include computing devices that typically connect using a wireless communications medium such as vehicles, vehicle sensors, cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more source devices within source devices 402-404 may be devices that are capable of connecting using a wired or wireless communication medium such as a PDA, POCKET PC, wearable computer, a laptop, tablet, desktop computer, a netbook,, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more source devices within source devices 402-404 may include may run one or more applications, such as Internet browsers, mobile applications, voice calls, videoconferencing, and email, among others. In some embodiments, one or more source devices within source devices 402-404 may be configured to receive and to send data such as telemetry data, and the like.

In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a source device within source devices 402-404 may be specifically programmed by either Java, .Net, QT, C, C++ and/or other suitable programming language.

In some embodiments, the exemplary network 405 may provide network access, data transport and/or other services to any computing device coupled to it. In some embodiments, the exemplary network 405 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 405 may implement one or more of a GSM architecture, a General Packet Radio Service (GPRS) architecture, a Universal Mobile Telecommunications System (UMTS) architecture, and an evolution of UMTS referred to as Long Term Evolution (LTE).

In some embodiments and, optionally, in combination of any embodiment described above or below, the exemplary network 405 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 405 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof.

In some embodiments, the exemplary network 405 may also include mass storage, such as network attached storage (NAS), a storage area network (SAN), a content delivery network (CDN) or other forms of computer or machine readable media.

In some embodiments, the exemplary server 406 or the exemplary server 407 may be a web server (or a series of servers) running a network operating system, examples of which may include but are not limited to Microsoft Windows Server, Novell NetWare, or Linux. In some embodiments, the exemplary server 406 or the exemplary server 407 may be used for and/or provide cloud and/or network computing.

In some embodiments, one or more of the exemplary servers 406 and 407 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the source devices 402-404.

In some embodiments and, optionally, in combination of any embodiment described above or below, for example, one or more exemplary source devices 402-404, the exemplary server 406, and/or the exemplary server 407 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

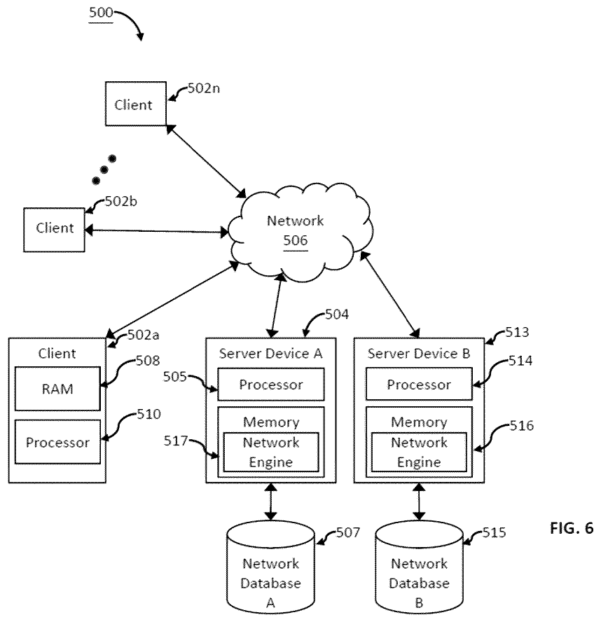

FIG. 6 depicts a block diagram of another exemplary computer-based system/platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the source computing devices 502a, 502b thru 502n shown each at least includes a computer-readable medium, such as a random-access memory (RAM) 508 coupled to a processor 510 or FLASH memory. Here, source (e.g., client) devices 502a, 502b thru 502n may be the plurality of N source data devices 305A . . . 305N.

In some embodiments, the processor 510 may execute computer-executable program instructions stored in memory 508. In some embodiments, the processor 510 may include a microprocessor, an ASIC, and/or a state machine. In some embodiments, the processor 510 may include, or may be in communication with, media, for example computer-readable media, which stores instructions that, when executed by the processor 510, may cause the processor 510 to perform one or more steps described herein. In some embodiments, examples of computer-readable media may include, but are not limited to, an electronic, optical, magnetic, or other storage or transmission device capable of providing a processor, such as the processor 510 of client 502a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, source computing devices 502a through 502n may also comprise a number of external or internal devices such as a mouse, a CD-ROM, DVD, a physical or virtual keyboard, a display, a speaker, or other input or output devices. In some embodiments, examples of source computing devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices.

In some embodiments, source computing devices 502a through 502n may be specifically programmed with one or more application programs in accordance with one or more principles/methodologies detailed herein. In some embodiments, source computing devices 502a through 502n may operate on any operating system capable of supporting a browser or browser-enabled application, such as Microsoft™, Windows™, and/or Linux. In some embodiments, source computing devices 502a through 502n shown may include, for example, personal computers executing a browser application program such as Microsoft Corporation's Internet Explorer™, Apple Computer, Inc.'s Safari™, Mozilla Firefox, and/or Opera. In some embodiments, through the source computing client devices 502a through 502n, may communicate over the exemplary network 506 with each other and/or with other systems and/or devices coupled to the network 506. As shown in FIG. 6, exemplary server devices 504 and 513 may be also coupled to the network 506. In some embodiments, one or more source computing devices 502a through 502n may be mobile clients.

In some embodiments, at least one database of exemplary databases 507 and 515 may be any type of database, such as the database 362 described above, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

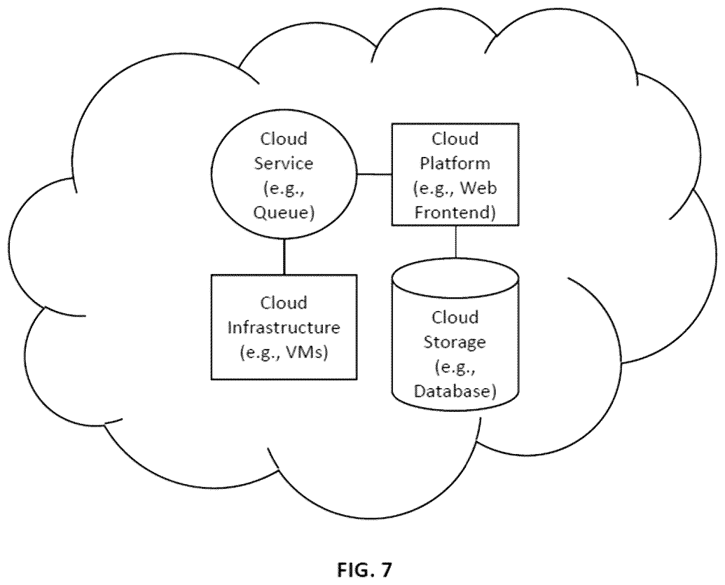

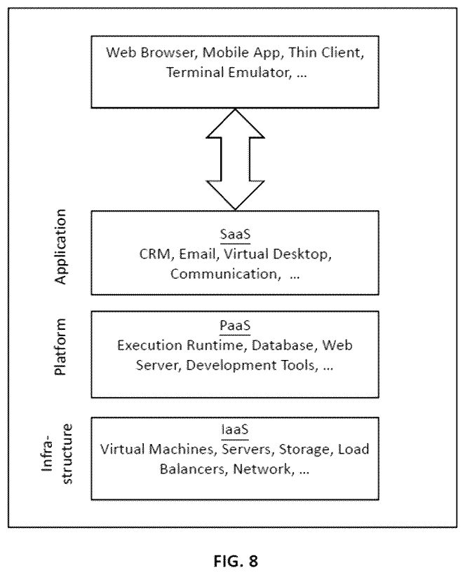

In some embodiments, the exemplary inventive computer-based systems/platforms, the exemplary inventive computer-based devices, and/or the exemplary inventive computer-based components of the present disclosure may be specifically configured to operate in an cloud computing/architecture such as, but not limiting to: infrastructure a service (IaaS), platform as a service (PaaS), and/or software as a service (SaaS). FIGS. 7 and 8 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

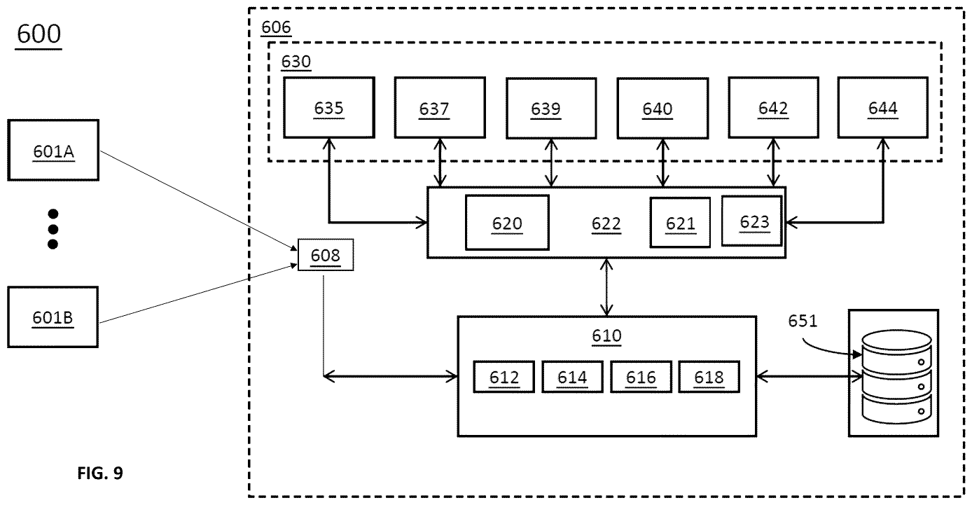

FIG. 9 is a block diagram of a system 600 for channel-agnostic telemetry data processing and event analysis (TDEA) based on a microservices platform 606 in accordance with one or more embodiments of the present disclosure. Aspects of the present disclosure may be applied to any embodiment for the (TDEA) microservices platform 606 that may include software modules denoted 635, 637, 639, 640 and 644 for implementing the TDEA microservices in a service layer 630 as described hereinbelow. The software modules 635, 637, 639, 640 and 644 may be for example, the batch processing pipeline 344, the noise filtering engine 346, the collision detection engine 348, the cost estimation software 352 and the repair assessment time software 354 as shown in FIG. 4.

In some embodiments, the TDEA microservices platform 606 may include a multi-layered architecture including, for example, the service layer 630, an orchestration layer 622, and a platform layer 610, however other layers may be additionally contemplated. In some embodiments, a plurality of data sources (e.g., generating telemetry data) may interact with the TDEA microservices platform 606 via any of N source devices denoted 601A . . . 601B, where N may be an integer. The N source devices denoted 601A . . . 601B may be equivalent to the N source devices 305A . . . 305B of FIG. 4 to interact with the TDEA microservices platform 606. Communications from the source devices 601A . . . 601B may be received by a communication circuitry 608 and may then be routed to an appropriate component of the system, via the platform layer 610, for example.

In some embodiments, the platform layer 610 may include an input/output (I/O) interface 612 for facilitating data communication to external devices, such as, e.g., the communication circuitry 608 with any other system devices. The platform layer 610 may also include a runtime environment 614 for implementing programs, services, functionalities and microservices using a plurality of processors 616 and memory devices 618 in a plurality of computing machines such as the M computing machines shown in FIG. 4 for implementing the TDEA microservices platform 606. The memory devices 618 may include, e.g., temporary storage and caching of data to facilitate resources of the TDEA microservices platform 606.

In some embodiments, the platform layer 610 includes functionality for, e.g., configuration management, logging and monitoring of data traffic, document management, communication routing, notifications, messaging tools, reporting tools, as well as any other functions pertaining to platform level functionality.

In some embodiments, the orchestrator 620 may manage operations of the TDEA microservices platform 606, including allocation of resources (e.g., add or removing any number of the computing machines) by a load balancer 623, process schedule with, e.g., the plurality of processors 616, among other tasks. For example, in some embodiments, the orchestrator 620 may include a plurality of application programming interfaces (APIs) 621 for calling services and functions of the TDEA microservices platform 606 in interacting with the source devices 601A . . . 601B.

In some embodiments, the orchestrator 620 may manage operations of microservices in a service layer 630 and coordination of the service layer 630 with the platform layer 610. For example, the service layer 630 may include software modules 635, 637, 639, 640 and 644 related to, for example, implementing the TDEA microservices platform for channel-agnostic telemetry data processing and event analysis (TDEA). In some embodiments, the orchestrator 620 may facilitate aggregation of data from multiple domains in the service layer 630 and/or may orchestrate data-related operations across domains and services to provide for complete experiences within any given domain.

In some embodiments, the database 651 (equivalent to the database 362) as described above may be separate from databases stored in the plurality of memories stored in the plurality of computing machines.

In some embodiments, any data stored the plurality of databases may be accessible from the N source devices 601A . . . 601B via any of the plurality of APIs 621 in the orchestration layer 622 in the TDEA microservices platform 606.

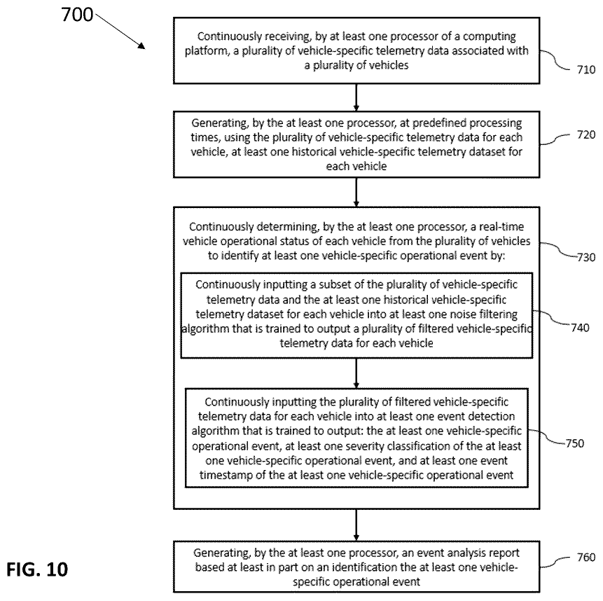

FIG. 10 is a flowchart of a method 700 for channel-agnostic telemetry data processing and event analysis in a computing platform in accordance with one or more embodiments of the present disclosure. The method 700 may be performed by the processor 340, for example.

In some embodiments, the method 700 may include continuously receiving 710, by at least one processor of a computing platform, a plurality of vehicle-specific telemetry data associated with a plurality of vehicles. The plurality of vehicle-specific telemetry data for each vehicle may include a plurality of vehicle-specific sensor data, at least one vehicle-specific location data, at least one location-specific environmental data, at least one audio-video vehicle-specific monitoring data, at least one unstructured vehicle-specific data, or any combination thereof.

In some embodiments, the method 700 may include generating 720, by the at least one processor, at predefined processing times (e.g., batch processing times), using the plurality of vehicle-specific telemetry data for each vehicle, at least one historical vehicle-specific telemetry dataset for each vehicle.

In some embodiments, the method 700 may include continuously determining 730, by the at least one processor, a real-time vehicle operational status of each vehicle from the plurality of vehicles to identify at least one vehicle-specific operational event by performing steps 740 and 750.

In some embodiments, the method 700 may include continuously inputting 740 a subset of the plurality of vehicle-specific telemetry data and the at least one historical vehicle-specific telemetry dataset for each vehicle into at least one noise filtering algorithm that is trained to output a plurality of filtered vehicle-specific telemetry data for each vehicle.

In some embodiments, the at least one noise filtering algorithm may be configured to correlate the at least one historical vehicle-specific telemetry dataset and the plurality of vehicle-specific telemetry data in the subset to filter redundant telemetry data, false telemetry data, or both, in the plurality of vehicle-specific telemetry data.

In some embodiments, the subset of the plurality of vehicle-specific telemetry data may facilitate a reduction in a telemetry data processing overhead during the continuous determining of the real-time vehicle operational status of each vehicle from the plurality of vehicles.

In some embodiments, the method 700 may include continuously inputting 750 the plurality of filtered vehicle-specific telemetry data for each vehicle into at least one event detection algorithm that is trained to output: the at least one vehicle-specific operational event, at least one severity classification of the at least one vehicle-specific operational event, and at least one event timestamp of the at least one vehicle-specific operational event.

In some embodiments, the at least one event detection algorithm is configured to identify the at least one vehicle-specific operational event for each vehicle based at least in part on a plurality of dependencies between: historical vehicle-specific telemetry data in the at least one historical vehicle-specific telemetry dataset, and the plurality of filtered vehicle-specific telemetry data.

In some embodiments, the method 700 may include generating 760, by the at least one processor, an event analysis report based at least in part on an identification the at least one vehicle-specific operational event.

According to some embodiments, the disclosed method can cause or provide, via a network application, server and/or cloud device, control and/or management of a vehicle based on the report analysis and generation, discussed above.

According to some embodiments, the implementation of vehicle control mechanisms based on report analysis involves the disclosed channel-agnostic telemetry framework, whereby, as discussed herein, when the framework ingests pre-written collision or accident reports through its multi-channel intake system (which accepts emails, files, SMS, social media posts, and other formats), the AI/ML analysis pipeline processes this unstructured data using Natural Language Processing (NLP) techniques. The framework employs transformer-based Large Language Models to extract critical information about vehicle conditions, environmental factors, and accident severity with 75% weighting given to the detailed explanation within the report itself. This extraction process utilizes named entity recognition, part-of-speech tagging, and sentiment analysis to build a comprehensive event profile that includes geographic coordinates, vehicle identification, damage assessment, and operational status evaluation.

Once processed, this information flows through the framework's real-time analysis mechanisms, which correlates the report data with historical telemetry patterns stored in distributed cloud databases. For example, in some embodiments, a correlation algorithm employs XGBoost classification models that have been specifically trained on vehicle make and model-specific datasets (weighted at 4.8%) combined with empirical data from previous similar incidents (weighted at 20.2%). This analysis generates a probabilistic model of the vehicle's current state, identifying potentially compromised systems with statistical confidence intervals. The predictive model is enhanced through sensor cohesion analysis, which evaluates the relationships between different sensor readings to validate the accuracy of the report-based assessment.

In some embodiments, the cloud-based control mechanisms of the framework then implement a three-tiered decision architecture for vehicle intervention. At the highest level, a strategic control layer evaluates overall vehicle operability and safety thresholds based on the damage analysis module's output. This layer employs graph-based data structures to model complex relationships between vehicle subsystems and determine whether remote intervention is necessary. The tactical layer translates these high-level decisions into specific control parameters for vehicle subsystems, utilizing a recurrent neural network architecture that has been trained on manufacturer-specific control protocols. This layer accounts for environmental conditions like weather (weighted at 7.69%) and geographical factors (weighted at 2.31%) when formulating control instructions. The operational layer handles the secure transmission of command packets to the vehicle's electronic control units through encrypted cellular or satellite communication channels.

In some embodiments, the framework can implement security protocols for remote vehicle control, utilizing multi-factor authentication and public-key infrastructure to verify command authenticity. Each control instruction is digitally signed using asymmetric encryption algorithms, with session keys rotated according to time-based protocols. The vehicle's onboard systems independently validate incoming commands against manufacturer-defined safety parameters before execution, providing an additional layer of protection against malicious or erroneous instructions. This bidirectional verification mechanism ensures that only appropriate and safe control actions are implemented based on the report analysis.

For practical implementation, the framework employs a graduated control approach based on the severity classification derived from the report analysis. For vehicles classified with minor incidents, the system may implement diagnostic mode activations, limiting certain performance parameters while maintaining basic functionality. In moderate severity cases, the control system might engage limp-home protocols, restricting vehicle operation to basic transportation functions while disabling potentially compromised systems. In severe cases where the vehicle operability assessment indicates critical safety concerns, the system can initiate full powertrain shutdown procedures through progressive deceleration protocols that maintain steering and braking functionality while bringing the vehicle to a safe stop.

In some embodiments, as discussed herein, the technical infrastructure supporting such control capability operates within a cloud-native microservices architecture deployed across redundant data centers with real-time failover capabilities. Each microservice handles specific aspects of the control pipeline, from report ingestion and analysis to command formulation and transmission. The system utilizes containerized deployment with Kubernetes orchestration to maintain high availability and scalability under varying load conditions. Load balancing mechanisms prioritize control-related traffic, ensuring that critical command instructions receive processing priority over less time-sensitive telemetry analysis.

Through such integrated approach, the disclosed framework extends beyond passive telemetry analysis to enable active vehicle control based on comprehensive report analysis. The implementation of sophisticated AI/ML models, secure communication protocols, and graduated control strategies allows for appropriate intervention based on accurately assessed vehicle conditions, enhancing safety and operational efficiency while maintaining robust security and compliance safeguards.

In some embodiments, a method may include continuously receiving, by at least one processor of a computing platform, a plurality of vehicle-specific telemetry data associated with a plurality of vehicles. The plurality of vehicle-specific telemetry data for each vehicle may include: a plurality of vehicle-specific sensor data, at least one vehicle-specific location data, at least one location-specific environmental data, at least one audio-video vehicle-specific monitoring data, at least one unstructured vehicle-specific data, or any combination thereof. At least one historical vehicle-specific telemetry dataset for each vehicle may be generated at predefined processing times using the plurality of vehicle-specific telemetry data for each vehicle. A real-time vehicle operational status of each vehicle from the plurality of vehicles may be continuously determined to identify at least one vehicle-specific operational event by continuously inputting a subset of the plurality of vehicle-specific telemetry data and the at least one historical vehicle-specific telemetry dataset for each vehicle into at least one noise filtering algorithm that is trained to output a plurality of filtered vehicle-specific telemetry data for each vehicle. The at least one noise filtering algorithm may be configured to correlate the at least one historical vehicle-specific telemetry dataset and the plurality of vehicle-specific telemetry data in the subset to filter redundant telemetry data, false telemetry data, or both, in the plurality of vehicle-specific telemetry data. The subset of the plurality of vehicle-specific telemetry data during the continuous determining of the real-time vehicle operational status of each vehicle from the plurality of vehicles may facilitate a reduction in a telemetry data processing overhead. The plurality of filtered vehicle-specific telemetry data for each vehicle may be continuously inputted into at least one event detection algorithm that is trained to output: the at least one vehicle-specific operational event, at least one severity classification of the at least one vehicle-specific operational event, and at least one event timestamp of the at least one vehicle-specific operational event. The at least one event detection algorithm may be configured to identify the at least one vehicle-specific operational event for each vehicle based at least in part on a plurality of dependencies between historical vehicle-specific telemetry data in the at least one historical vehicle-specific telemetry dataset, and the plurality of filtered vehicle-specific telemetry data. An event analysis report based at least in part on an identification the at least one vehicle-specific operational event may be generated.

In some embodiments, the continuous receiving of the plurality of vehicle-specific telemetry data may include continuously receiving the plurality of vehicle-specific telemetry data that is generated based on a segregation, using a plurality of vehicle identifiers, of a plurality of telemetry data associated with the plurality of vehicles into the plurality of vehicle-specific telemetry data. The plurality of telemetry data in a plurality of data streams may be sent to the computing platform over a plurality of communication channels from a plurality of data sources.

In some embodiments, the segregation of the plurality of telemetry data using the plurality of vehicle identifiers may be performed on the computing platform, at least one external server, at least one other computing platform, or any combination thereof.

In some embodiments, the at least one unstructured vehicle-specific data associated with each vehicle may include an email, a text-based cellular communication, an International Mobile Equipment Identity (IMEI) number, a user profile information, a Short Message Service (SMS) text, Multimedia Messaging Service (MMS), a social media post, a social media feed, a printed report, or any combination thereof.

In some embodiments, the generating of the at least one historical vehicle-specific telemetry dataset for each vehicle may include applying at least one natural language processing (NLP) algorithms, at least one image processing algorithm, or both, to the at least one unstructured vehicle-specific data associated with each vehicle.

In some embodiments, the method may further include applying, by the at least one processor, at least one load balancing algorithm to use load balancers to activate or deactivate any of a plurality of computing machines of the computing platform so as to adaptively control the telemetry data processing overhead in the computing platform for processing the plurality of vehicle-specific telemetry data associated with the plurality of vehicles.

In some embodiments, the at least one location-specific environmental data in the plurality vehicle-specific telemetry data for each vehicle may include at least one weather condition report at a location of the at least one vehicle-specific operational event for each vehicle.

In some embodiments, the at least one vehicle-specific operational event for each vehicle may be at least one vehicle collision.

In some embodiments, the at least one severity classification of the at least one vehicle collision may be a classification of a drivable vehicle, a minorly damaged vehicle, a moderately damaged vehicle, or a severely damaged vehicle.

In some embodiments, the generating of the event analysis report based at least in part on the identification of the at least one vehicle collision may include generating at least one of: at least one damage assessment of each vehicle after the identification, at least one cost estimation to repair each vehicle after the identification, or at least one repair time estimation to repair each vehicle after the identification.

In some embodiments, a system may include at least one processor of a computing platform and at least one non-transitory memory storing computer code. The at least one processor may be configured to execute the computer code that causes the at least one processor to: continuously receive a plurality of vehicle-specific telemetry data associated with a plurality of vehicles; where the plurality of vehicle-specific telemetry data for each vehicle comprises: a plurality of vehicle-specific sensor data, at least one vehicle-specific location data, at least one location-specific environmental data, at least one audio-video vehicle-specific monitoring data, at least one unstructured vehicle-specific data, or any combination thereof; generate, at predefined processing times, using the plurality of vehicle-specific telemetry data for each vehicle, at least one historical vehicle-specific telemetry dataset for each vehicle; continuously determine a real-time vehicle operational status of each vehicle from the plurality of vehicles to identify at least one vehicle-specific operational event by: continuous input of a subset of the plurality of vehicle-specific telemetry data and the at least one historical vehicle-specific telemetry dataset for each vehicle into at least one noise filtering algorithm that is trained to output a plurality of filtered vehicle-specific telemetry data for each vehicle; where the at least one noise filtering algorithm may be configured to correlate the at least one historical vehicle-specific telemetry dataset and the plurality of vehicle-specific telemetry data in the subset to filter redundant telemetry data, false telemetry data, or both, in the plurality of vehicle-specific telemetry data; where the subset of the plurality of vehicle-specific telemetry data may facilitate a reduction in a telemetry data processing overhead during the continuous determining of the real-time vehicle operational status of each vehicle from the plurality of vehicles; continuous input of the plurality of filtered vehicle-specific telemetry data for each vehicle into at least one event detection algorithm that is trained to output: the at least one vehicle-specific operational event, at least one severity classification of the at least one vehicle-specific operational event, and at least one event timestamp of the at least one vehicle-specific operational event; where the at least one event detection algorithm may be configured to identify the at least one vehicle-specific operational event for each vehicle based at least in part on a plurality of dependencies between: historical vehicle-specific telemetry data in the at least one historical vehicle-specific telemetry dataset, and the plurality of filtered vehicle-specific telemetry data; and generate an event analysis report based at least in part on an identification the at least one vehicle-specific operational event.

In some embodiments, the at least one processor may be configured to continuous receive the plurality of vehicle-specific telemetry data by continuously receiving the plurality of vehicle-specific telemetry data that is generated based on a segregation, using a plurality of vehicle identifiers, of a plurality of telemetry data associated with the plurality of vehicles into the plurality of vehicle-specific telemetry data. The plurality of telemetry data in a plurality of data streams may be sent to the computing platform over a plurality of communication channels from a plurality of data sources.

In some embodiments, the segregation of the plurality of telemetry data using the plurality of vehicle identifiers may be performed on the computing platform, at least one external server, at least one other computing platform, or any combination thereof.

In some embodiments, the at least one unstructured vehicle-specific data associated with each vehicle may include an email, a text-based cellular communication, an International Mobile Equipment Identity (IMEI) number, a user profile information, a Short Message Service (SMS) text, Multimedia Messaging Service (MMS), a social media post, a social media feed, a printed report, or any combination thereof.

In some embodiments, the at least one processor may be configured to generate the at least one historical vehicle-specific telemetry dataset for each vehicle by applying at least one natural language processing (NLP) algorithms, at least one image processing algorithm, or both, to the at least one unstructured vehicle-specific data associated with each vehicle.

In some embodiments, the system may further include load balancers. The at least one processor may be further configured to apply at least one load balancing algorithm to use the load balancers to activate or deactivate any of a plurality of computing machines of the computing platform so as to adaptively control the telemetry data processing overhead in the computing platform for processing the plurality of vehicle-specific telemetry data associated with the plurality of vehicles.

In some embodiments, the at least one location-specific environmental data in the plurality of vehicle-specific telemetry data for each vehicle may include at least one weather condition report at a location of the at least one vehicle-specific operational event for each vehicle.

In some embodiments, the at least one vehicle-specific operational event for each vehicle may be at least one vehicle collision.

In some embodiments, the at least one severity classification of the at least one vehicle collision may be a classification of a drivable vehicle, a minorly damaged vehicle, a moderately damaged vehicle, or a severely damaged vehicle.

In some embodiments, the at least one processor may be configured to generate the event analysis report based at least in part on the identification of the at least one vehicle collision by generating at least one of: at least on damage assessment of each vehicle after the identification, at least one cost estimation to repair each vehicle after the identification, or at least one repair time estimation to repair each vehicle after the identification.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

What is claimed is:

1. A method comprising:
receiving, by at least one processor of a computing platform, a plurality of vehicle-specific telemetry data associated with a plurality of vehicles;
wherein the plurality of vehicle-specific telemetry data for each vehicle comprises:
a plurality of vehicle-specific sensor data,
at least one vehicle-specific location data,
at least one location-specific environmental data,
at least one audio-video vehicle-specific monitoring data,
at least one unstructured vehicle-specific data, or any combination thereof;
generating, by the at least one processor, at predefined processing times, using the plurality of vehicle-specific telemetry data for each vehicle, at least one historical vehicle-specific telemetry dataset for each vehicle;
continuously determining, by the at least one processor, a real-time vehicle operational status of each vehicle from the plurality of vehicles to identify at least one vehicle-specific operational event by:
continuously inputting a subset of the plurality of vehicle-specific telemetry data and the at least one historical vehicle-specific telemetry dataset for each vehicle into at least one noise filtering algorithm that is trained to output a plurality of filtered vehicle-specific telemetry data for each vehicle;
wherein the at least one noise filtering algorithm is configured to correlate the at least one historical vehicle-specific telemetry dataset and the plurality of vehicle-specific telemetry data in the subset to filter redundant telemetry data, false telemetry data, or both, in the plurality of vehicle-specific telemetry data;
wherein the subset of the plurality of vehicle-specific telemetry data facilitates a reduction in a telemetry data processing overhead during the continuous determining of the real-time vehicle operational status of each vehicle from the plurality of vehicles;
continuously inputting the plurality of filtered vehicle-specific telemetry data for each vehicle into at least one event detection algorithm that is trained to output:
the at least one vehicle-specific operational event,
at least one severity classification of the at least one vehicle-specific operational event, and
at least one event timestamp of the at least one vehicle-specific operational event;
wherein the at least one event detection algorithm is configured to identify the at least one vehicle-specific operational event for each vehicle based at least in part on a plurality of dependencies between:
historical vehicle-specific telemetry data in the at least one historical vehicle-specific telemetry dataset, and
the plurality of filtered vehicle-specific telemetry data; and
generating, by the at least one processor, an event analysis report based at least in part on an identification the at least one vehicle-specific operational event.

2. The method according to claim 1, wherein the continuous receiving of the plurality of vehicle-specific telemetry data comprises continuously receiving the plurality of vehicle-specific telemetry data that is generated based on a segregation, using a plurality of vehicle identifiers, of a plurality of telemetry data associated with the plurality of vehicles into the plurality of vehicle-specific telemetry data;
wherein the plurality of telemetry data in a plurality of data streams is sent to the computing platform over a plurality of communication channels from a plurality of data sources.

3. The method according to claim 2, wherein the segregation of the plurality of telemetry data using the plurality of vehicle identifiers is performed on the computing platform, at least one external server, at least one other computing platform, or any combination thereof.

4. The method according to claim 1, wherein the at least one unstructured vehicle-specific data associated with each vehicle comprises an email, a text-based cellular communication, an International Mobile Equipment Identity (IMEI) number, a user profile information, a Short Message Service (SMS) text, Multimedia Messaging Service (MMS), a social media post, a social media feed, a printed report, or any combination thereof.

5. The method according to claim 4, wherein the generating of the at least one historical vehicle-specific telemetry dataset for each vehicle comprises applying at least one natural language processing (NLP) algorithms, at least one image processing algorithm, or both, to the at least one unstructured vehicle-specific data associated with each vehicle.

6. The method according to claim 1, further comprising applying, by the at least one processor, at least one load balancing algorithm to use load balancers to activate or deactivate any of a plurality of computing machines of the computing platform so as to adaptively control the telemetry data processing overhead in the computing platform for processing the plurality of vehicle-specific telemetry data associated with the plurality of vehicles.

7. The method according to claim 1, wherein the at least one location-specific environmental data in the plurality vehicle-specific telemetry data for each vehicle comprises at least one weather condition report at a location of the at least one vehicle-specific operational event for each vehicle.

8. The method according to claim 1, wherein the at least one vehicle-specific operational event for each vehicle is at least one vehicle collision.

9. The method according to claim 8, wherein the at least one severity classification of the at least one vehicle collision is a classification of a drivable vehicle, a minorly damaged vehicle, a moderately damaged vehicle, or a severely damaged vehicle.

10. The method according to claim 8, wherein the generating of the event analysis report based at least in part on the identification of the at least one vehicle collision comprises generating at least one of:
at least one damage assessment of each vehicle after the identification,
at least one cost estimation to repair each vehicle after the identification, or
at least one repair time estimation to repair each vehicle after the identification.

11. A system, comprising:
at least one processor of a computing platform; and
at least one non-transitory memory storing computer code;
wherein the at least one processor is configured to execute the computer code that causes the at least one processor to:
continuously receive a plurality of vehicle-specific telemetry data associated with a plurality of vehicles;
wherein the plurality of vehicle-specific telemetry data for each vehicle comprises:
a plurality of vehicle-specific sensor data,
at least one vehicle-specific location data,
at least one location-specific environmental data,
at least one audio-video vehicle-specific monitoring data,
at least one unstructured vehicle-specific data, or any combination thereof;
generate, at predefined processing times, using the plurality of vehicle-specific telemetry data for each vehicle, at least one historical vehicle-specific telemetry dataset for each vehicle;
continuously determine a real-time vehicle operational status of each vehicle from the plurality of vehicles to identify at least one vehicle-specific operational event by:
continuous input of a subset of the plurality of vehicle-specific telemetry data and the at least one historical vehicle-specific telemetry dataset for each vehicle into at least one noise filtering algorithm that is trained to output a plurality of filtered vehicle-specific telemetry data for each vehicle;
wherein the at least one noise filtering algorithm is configured to correlate the at least one historical vehicle-specific telemetry dataset and the plurality of vehicle-specific telemetry data in the subset to filter redundant telemetry data, false telemetry data, or both, in the plurality of vehicle-specific telemetry data;
wherein the subset of the plurality of vehicle-specific telemetry data facilitates a reduction in a telemetry data processing overhead during the continuous determining of the real-time vehicle operational status of each vehicle from the plurality of vehicles;
continuous input of the plurality of filtered vehicle-specific telemetry data for each vehicle into at least one event detection algorithm that is trained to output:
the at least one vehicle-specific operational event,
at least one severity classification of the at least one vehicle-specific operational event, and
at least one event timestamp of the at least one vehicle-specific operational event;
wherein the at least one event detection algorithm is configured to identify the at least one vehicle-specific operational event for each vehicle based at least in part on a plurality of dependencies between:
historical vehicle-specific telemetry data in the at least one historical vehicle-specific telemetry dataset, and
the plurality of filtered vehicle-specific telemetry data; and
generate an event analysis report based at least in part on an identification the at least one vehicle-specific operational event.

12. The system according to claim 11, wherein the at least one processor is configured to continuous receive the plurality of vehicle-specific telemetry data by continuously receiving the plurality of vehicle-specific telemetry data that is generated based on a segregation, using a plurality of vehicle identifiers, of a plurality of telemetry data associated with the plurality of vehicles into the plurality of vehicle-specific telemetry data;
wherein the plurality of telemetry data in a plurality of data streams is sent to the computing platform over a plurality of communication channels from a plurality of data sources.

13. The system according to claim 12, wherein the segregation of the plurality of telemetry data using the plurality of vehicle identifiers is performed on the computing platform, at least one external server, at least one other computing platform, or any combination thereof.

14. The system according to claim 11, wherein the at least one unstructured vehicle-specific data associated with each vehicle comprises an email, a text-based cellular communication, an International Mobile Equipment Identity (IMEI) number, a user profile information, a Short Message Service (SMS) text, Multimedia Messaging Service (MMS), a social media post, a social media feed, a printed report, or any combination thereof.

15. The system according to claim 14, wherein the at least one processor is configured to generate the at least one historical vehicle-specific telemetry dataset for each vehicle by applying at least one natural language processing (NLP) algorithms, at least one image processing algorithm, or both, to the at least one unstructured vehicle-specific data associated with each vehicle.

16. The system according to claim 11, further comprising load balancers; and
wherein the at least one processor is further configured to apply at least one load balancing algorithm to use the load balancers to activate or deactivate any of a plurality of computing machines of the computing platform so as to adaptively control the telemetry data processing overhead in the computing platform for processing the plurality of vehicle-specific telemetry data associated with the plurality of vehicles.

17. The system according to claim 11, wherein the at least one location-specific environmental data in the plurality of vehicle-specific telemetry data for each vehicle comprises at least one weather condition report at a location of the at least one vehicle-specific operational event for each vehicle.

18. The system according to claim 11, wherein the at least one vehicle-specific operational event for each vehicle is at least one vehicle collision.

19. The system according to claim 18, wherein the at least one severity classification of the at least one vehicle collision is a classification of a drivable vehicle, a minorly damaged vehicle, a moderately damaged vehicle, or a severely damaged vehicle.

20. The system according to claim 18, wherein the at least one processor is configured to generate the event analysis report based at least in part on the identification of the at least one vehicle collision by generating at least one of:
at least one damage assessment of each vehicle after the identification,
at least one cost estimation to repair each vehicle after the identification, or
at least one repair time estimation to repair each vehicle after the identification.
